(19) United States
(12) Patent Application Publication
(10) Pub. No.: US 2013/0061265 A1
(43) Pub. Date: Mar. 7, 2013

(54) METHODS AND SYSTEMS FOR REAL TIME DELIVERY TO AT LEAST ONE USER ADDITIONAL CONTENT/SERVICES ASSOCIATED WITH TELEVISION/RADIO PROGRAMS

(71) Applicant: Giampiero Recco, Roma (IT)

(72) Inventor: Giampiero Recco, Roma (IT)

(73) Assignee: X2TV S.R.I., PULA (IT)

(21) Appl. No.: 13/582,438

(22) PCT Filed: Mar. 3, 2010
(86) PCT No.: PCT/IT10/00091

§ 371 Date: Nov. 12, 2012

(51) Int. Cl. H04N 21/431

(52) U.S. Cl. 725/40

(57) ABSTRACT

Methods and systems are provided for real time delivery to at least one user additional content/services associated with programs broadcast by television/radio and intended to be received/used by the user through a standard television/radio receiving device, said additional content/services being suitable for being accessed by the user through a client device equipped with a graphical display interface distinct from the standard television/radio receiving device.

The present description refers to a method and to a system for delivering in real time additional contents/services associated with a television/radio programme.

Recently, digital technologies have led to the development and widespread use of so-called interactive TV systems. Such systems allow a user who watches a television entertainment programme through a television receiver, and an associated display and sound reproduction device, to take up an active role in the enjoyment of the programme. Indeed, the aforementioned interactive TV systems allow the user to make choices to selectively access additional contents/services through the same receiver, and through the associated display and sound reproduction device used to following the programme being broadcast.

The aforementioned additional content and services access mode used in interactive TV systems has some drawbacks.

Firstly, the aforementioned access mode forces all viewers of the programme being shown that simultaneously use the same receiver, thinking for example of a family of people, to go along with the choice of the particular user that has made the selection.

In addition, the aforementioned access mode has the drawback given by the fact that during access to the additional contents/services the television programme goes into the background (for example, it is reduced to a small window) for which reason the user in a certain sense actually suspends viewing of the programme.

Moreover, the aforementioned access mode requires a significant increase in band with respect to the amount of band strictly necessary to broadcast the programme. Therefore, in order to avoid the use of large band resources at will, the number of additional contents and services available is generally very limited. Precisely for this reason, the type of additional contents/services available is not always specific for a given programme, in other words many programmes share the same additional contents and services that therefore are decontextualised from the specific programmes and are not synchronised with them.

Finally, the aforementioned access mode foresees that the number and type of additional contents/services be strictly set by the operators of the system for which reason as soon as the additional contents and services available are changed, the previous ones are no longer available, whereas it could for example be desirable to extend the possibility of access over time, for example so as to allow a user to fully use an additional content or service already started before the change imposed by the operator.

The state of the art has solutions different from interactive TV, which foresee creating a website associated with the programme to deliver additional contents/services associated with a programme and that are static while the programme is being broadcast (i.e. that are not updated in real time while the programme is being broadcast being updated for example weekly or based on even longer time periods). However, the aforementioned solutions do not ensure contextuality and synchrony with respect to the programme being broadcast. Moreover, the aforementioned solutions require that the user be highly motivated, since they have to switch on a pc, establish an internet connection, type in the internet address of the site hosting the webpage in full, etc. and it is highly improbable that this occurs while a user is watching a television programme because the aforementioned operations force the user to actually suspend viewing of the programme. Moreover, in the case in which on the same channel one programme moves on to the next, the user should search for and consult another website or another address where additional contents/services associated with the new programme being broadcast can be found.

There is therefore a great need to have a method for delivering additional contents/services associated with a programme broadcasted by television/radio that does not have the drawbacks of the aforementioned access systems of the prior art.

The present description proposes as its purpose to provide a method that allows the requirement indicated above to be satisfied.

The aforementioned purpose is achieved through a method as defined in general in the attached first claim in its most general form and in the dependent claims in some particular embodiments.

A further purpose of the present description is to provide a system for delivering additional contents/services associated with television/radio programmes transmitted through broadcasting in real time that does not have the drawbacks of the aforementioned interactive television systems of the prior art.

A further purpose of the present description is to provide a client for access to the aforementioned additional contents/services.

The invention will be better understood from the following detailed description of embodiments thereof given as an example and therefore in no way limiting in relation to the attached drawings, in which:

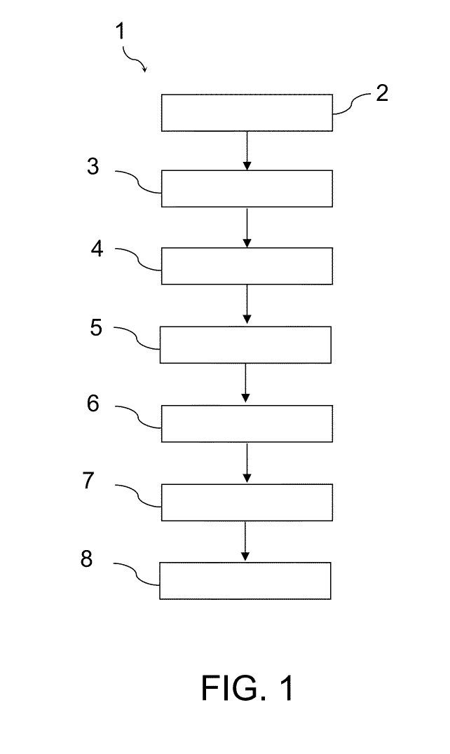

FIG. 1 shows a flow chart of an example of an access method for delivering in real time additional contents/services associated with a programme broadcasted by television/radio;

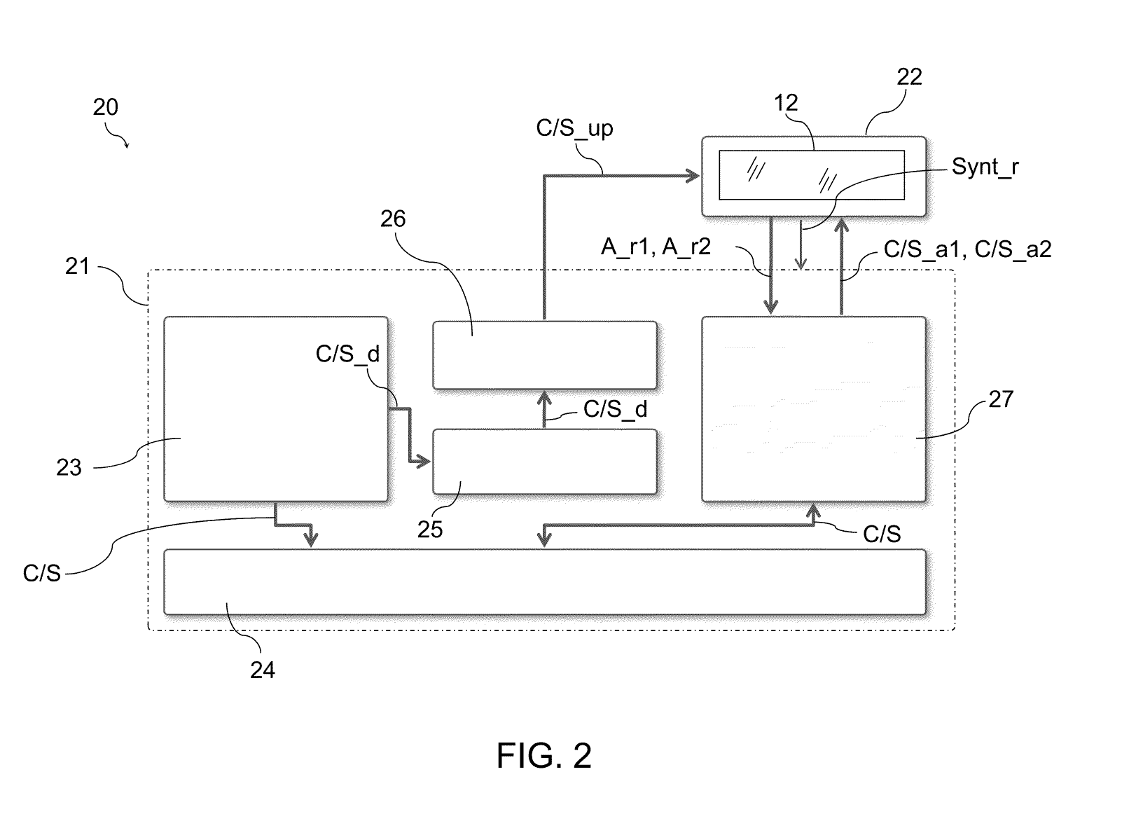

FIG. 2 shows a non-limiting example functional block diagram of a system for delivering additional contents/services associated with a programme broadcasted by television/radio, the system comprising at least one server for delivering additional services/contents and at least one client;

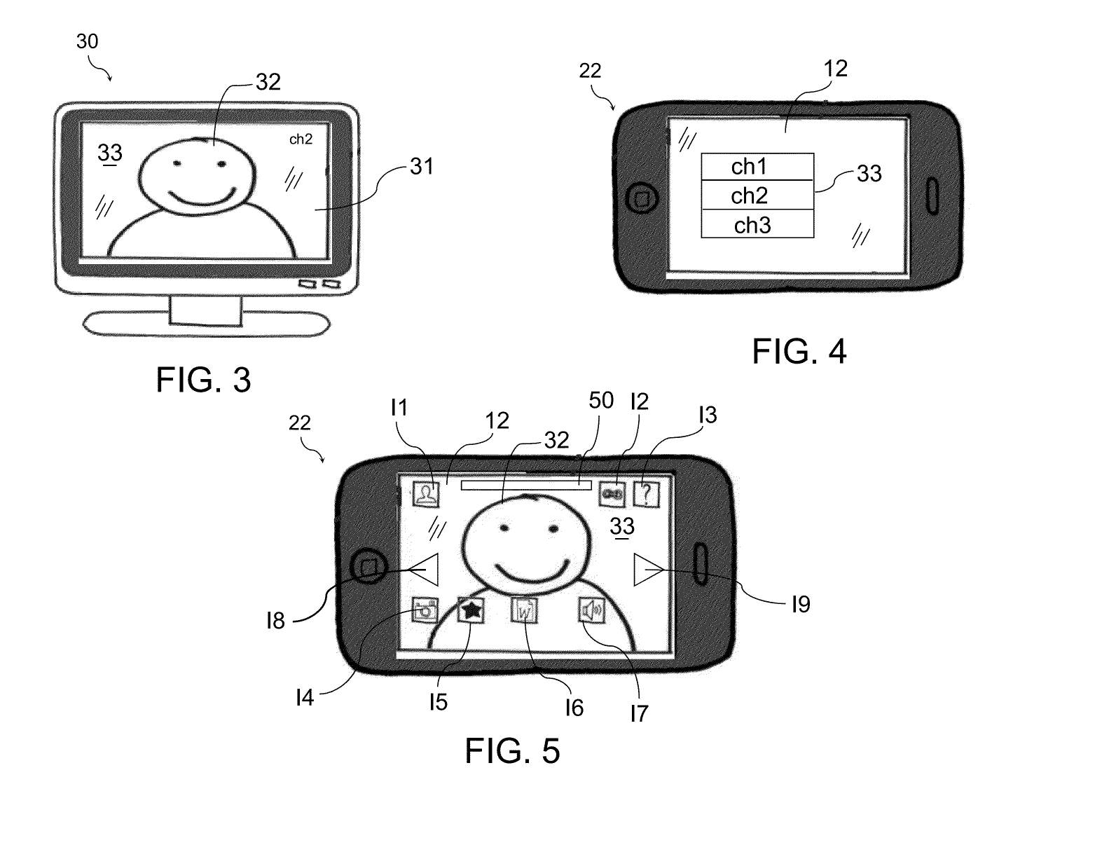

FIG. 3 schematically shows a standard television receiver device;

FIGS. 4 and 5 show a particular example of a graphical interface adapted to be used in the client of the system of FIG. 2.

In the figures, elements that are the same or similar are indicated with the same reference numerals.

With reference to FIG. 1, reference numeral 1 globally indicates the flow chart of a method for real time delivering to at least one user additional contents/services associated with a programme, like for example an entertainment programme, broadcasted by television/radio and intended to be received/used by the user through a standard television and/or radio receiver device. For example, in the case of a television programme the standard television receiver device is in the form of a television set, for example an LCD or plasma or LED television set comprising, or connected to, a digital decoder.

FIG. 2 represents the functional block diagram of a telecommunications system through which the method of FIG. 1 can be actuated. In FIG. 2 reference numeral 22 generically indicates the “client”, i.e. the receiver device through which a user can access the additional contents/services whereas reference numeral 21 generically indicates the “delivery server”, i.e. the entity, or the set of hardware/software components, that allows the additional contents/services to be delivered.

In accordance with an embodiment, the client 22 is a personal mobile communication device equipped with a graphic display interface 12. In accordance with a more specific embodiment, the client 22 is a dedicated electronic device equipped with:

an LCD display 12 with resolution preferably greater than or equal to 176×144 pixels;

a connection interface to the Internet or to another data network (like for example WiFi, 2G, 3G), preferably wireless;

a pointing and entry interface (for example comprising a touch screen and/or comprising hardware buttons and/or comprising a trackpad or in general any other pointing, entry or selection system);

a processing unit and one or more memory units selected so as to be suitable for processing static digital images.

Alternatively, the aforementioned client 22 is not a dedicated device and for example is in practice in the form of a cellular telephone device with suitable software on board. In accordance with a further embodiment, the aforementioned client 22 is in practice a latest generation multifunctional remote control equipped with a suitable display and with a connection interface to the Internet or to another data network.

The delivery server 21, on the other hand, represents a transmission system capable of sending, in real time and in synchrony with respect to the broadcasting of the programme, to the clients 22 the additional available contents/services associated with the programme and the notifications of availability of said contents/services. The delivery server 21 also constitutes the infrastructure used to collect, order and distribute the additional contents produced and/or to give access to the additional services offered, for example interactive services.

It is clear that the aforementioned delivery server 21 is a hardware/software system that can without distinction be either a single processing unit on which different software modules take part or a distributed assembly of processing units interconnected with each other, each intended to perform one or more specific functions.

With reference to FIG. 1, henceforth we shall mainly describe the different steps of the delivery method 1 and the components of the system 20 (FIG. 2) will be described as they are quoted in the description of the steps of the method 1.

In accordance with an embodiment, the delivery method 1 comprises a step 2 of producing additional contents/services (schematically indicated by reference numeral C/S in FIG. 2) with respect to a television/radio programme to be broadcast. For example, such additional contents/services C/S are in the form of contextual material semantically correlated to the information conveyed through the programme and for example are in the form of more detailed material with respect to some themes dealt with during the programme, additional text information regarding the presenters/participants in the programme, galleries of images and videos linked to the locations or participants/presenters of the programme, audio/video files in general, athletes' profiles, statistics or classifications for example in the case in which the programme is a sports programme, interactive services like for example the possibility of casting votes or expressing preferences, electronic purchasing of gadgets or in general of material linked to the programme, etc.

Preferably, the production step 2 is carried out by an operator through software, installed on a suitable processing unit, for example conceptually similar to the software used for film editing and audio/video editing but adapted to the particular requirements of flexibility needed by the specific application in question. More preferably, the production step 2 is carried out using editing software based on production models to be filled in that allow the additional contents/services C/S to be produced either in real time while the programme is being broadcast or in advance with respect to such a broadcast.

With reference to the block diagram of the system 20 represented in FIG. 2, the aforementioned production step 2 is carried out through a back-end, or hardware/software module, or production server 23.

The production back end 23 represents an important innovative element with respect to conventional interactive TV systems where typically it is an independent tool that mainly compiles the interactive contents in the suitable format so that they can be transmitted by the broadcasters.

In the system 20 described, the production back end 23 is an integral part of the server 21 since the ability to continuously transmit additional contents/services C/S updated in real time requires a high degree of integration between the tools for creating the contents themselves and the tools used to publish them and transmit them.

The production back end 23 is thus structured so as to be able to collect and consolidate the additional contents/services C/S to make them able to be immediately published. For every programme to be broadcast, the production back end 23 allows archiving of finished contents, ready to be transmitted, and incomplete contents for use in the production step such as:

Stills;

Icons and connected contents;

Time line with the sequence of stills to be transmitted;

Multimedia contents (web pages, audio/video files, connections to external websites);

Text contents;

Connections to interactive services.

The structure of the production back end 23 preferably comes from cinematography and inherits numerous concepts from the tools and from the production back end and audio/video editing together with characteristic elements expressly designed for the service in object. The delivery server 21 operates both as a final container of the programmes produced and as a digital container of the contents to be used for subsequent editing steps, and to directly connect the production with the transmission of the contents created or of the services provided in real time.

In accordance with an embodiment, the production back end 23 is not equipped with its own graphical interface and communicates with a production tool through dedicated APIs (Application Program Interface).

In accordance with an embodiment, the production back end 23 is developed so as to be flexible and able to be quickly modified so as to follow the evolution of the additional contents/services C/S able to be delivered. In accordance with an embodiment, the production back end 23 is implemented with hardware/software Application Server solutions for Web services.

Returning to the diagram of FIG. 1, in accordance with an embodiment, the method 1 also comprises a step of storing 3, on a suitable storage support, like for example a database 24 (FIG. 2), the additional contents/services C/S produced in the production step 2. The database 24 can without distinction be local or remote with respect to the production back end 23 but in general also with respect to any further component of the delivery server 21.

Again with reference to FIG. 1, the method 1 also comprises a step 4 of providing a hardware/software module for sending notifications (25-26, FIG. 3) with updated data (reference C/S_d in FIG. 2) concerning the availability of the additional contents/services C/S associated with the programme to be broadcast and/or being broadcast.

In accordance with an embodiment, in the aforementioned step 4, advantageously, the hardware/software module for sending notifications 25-26 is not provided with exactly the same additional contents/services C/S but only a series of information/data C/S_d concerning their availability and synchronisation information/data C/S_d with respect to the programme to be broadcast or being broadcast, so that the hardware/software module for sending notifications 25-26 can send the client 22 notifications of availability C/S_up of additional contents/services C/S in accordance with a precise time scheduling aimed at obtaining a substantial synchronisation with the programme while it is being broadcast. In accordance with an embodiment, the information C/S_d provided in step 4 to the notification sending module 25-26 also comprise information suitable for allowing a user to identify, directly or indirectly, the type of additional contents/services.

In accordance with an embodiment, the method 1 comprises a step 5 of receiving a notification request Synt_R sent by the user through the client 22. In accordance with an embodiment, such a notification request Synt_R is sent by the user in practice when the user selects through the client 22, for example through selection of an entry of a list of many entries, a specific television/radio channel with which to “virtually tune” his client 22, so that it can receive notifications C/S_up relating to additional available contents/services C/S associated with a programme being broadcast on such a channel in real time. After the aforementioned selection by the user, the delivery server 21 is in practice informed, through sending of a suitable notification request message/signal Synt_r (containing data identifying the client and the programme and/or channel), of the fact that the user wishes to receive through the client 22, in real time, information on the availability of additional contents/services C/S associated with the programme being broadcast on the selected channel. Preferably, the client 22 is developed so that the aforementioned selection of the channel on which to carry out the “virtual tuning” is carried out by the user through relatively simple and intuitive interface operations characterised by the same simplicity and intuitiveness of the selection operations used in the prior art to selected a channel to watch a television/radio programme transmitted through broadcasting on such a channel. As known, the aforementioned selection operations are generally carried out in the prior art through the remote control associated with a television/radio reproduction device in practice by selecting a “number” associated with the channel and/or by browsing through the various channels with channel up and down buttons “+” and “−”. For this reason, the client 22 is developed so as to allow the user to send the aforementioned notification request Synt_r through:

direct entry (through a conventional keypad or touchscreen) of a number associated with the channel on which the programme is being broadcast (for example “1” or “2” or “99”, etc.); and/or

through entry of directional controls “+”, “−” or “up”, “down” to move from one channel to the next one or previous one; and/or

through selection of a channel from a predefined list of available channels displayed through the graphical interface 12.

With reference to the diagram of FIG. 1, the method 1 comprises a subsequent step of transmitting 6, after the notification request message/signal Synt_r sent by the client 22 has been received and while the selected programme is being broadcast and in synchrony with it, through the hardware/software module for sending notifications 25-26 and to the client 22, notification data C/S_up, suitable for informing the client 22 about the availability of additional contents/services C/S, and more specifically for allowing information relating to the availability of additional contents/services C/S associated with the selected programme being broadcast to be displayed on the graphical interface 12 of the client 22.

The aforementioned transmitting step 6 is carried out periodically according to update periods of predetermined duration and/or of variable duration based on the updating in real time of additional available contents/services C/S associated with the selected programme.

With reference to FIG. 2, in accordance with an embodiment, the aforementioned transmission step 6 of the notification data C/S_up, or in short notifications C/S_up, is carried out through a server, module or back end 25, 26 for distributing notifications comprising a scheduler 25 and a real-time push server 26.

In accordance with an embodiment, the real time push server 26 is based on standard technologies mediated by high performance systems already implemented for online trading and for financial analysis, systems that require and are able to ensure an update frequency of less than one second.

The scheduler 25 is the element of the delivery server 21 used to plan the delivery of the additional contents/services C/S and to synchronise it with the broadcasting of the programme. Its task is to send the updated data C/S_d relating to the availability of additional contents/services to the real-time push server 26 at the right moment.

The scheduler 25 surveys the perfect synchronisation between the television broadcast and the additional contents. In the system in object the update frequency can also be very high particularly if the system is used to manage many programmes simultaneously. For the implementation of the scheduler 25 it is possible to use components already available on the market typically used to guide the workflows of complex e-commerce systems or else to synchronise financial transactions.

The scheduler 25 interfaces upstream with the production back end 23 that provides the data C/S_d of availability of the contents/services and the time line according to which they are planned and downstream with the real-time push server 26 that performs the task of transmitting the aforementioned data C/S_d to all of the connected clients 22.

In order to simplify integration, in accordance with an embodiment, the interconnection between production back end 23 and the scheduler 25 is implemented using API with remote access (for example REST) whereas, in order to optimise performance, the interface between the scheduler 25 and real-time push server 26 is preferably implemented within the same Application Server.

In accordance with an embodiment, in order to ensure the maximum compatibility with the available networks and with the configurations typically carried out by network operators, the real time push server 26, to send the clients 22 notification data C/S_up of updates in real time relating to the availability of additional contents/services C/S available, uses standard HTTP protocol (RFC 2616) in “push” or “long polling” mode.

It should be observed that, contrary to what occurs in interactive TV systems of the state of the art, in accordance with an embodiment, the real time push server can be used in the system 20 solely to send the clients 22 a pointer C/S_up (or more than one pointer) to the additional contents/services C/S available, or i.e. notification data C/S_up, and not the additional contents/services themselves. The aforementioned notification data C/S_up, informs the client 22 that new additional contents/services are available and includes identifying data that allows the client 22 to directly recover said additional contents/services C/S from the storage support 24, or to recover, again from the storage support 24, information to be displayed on the graphical interface 22 relating to the additional contents/services C/S available.

The aforementioned important innovative element leads to numerous advantages and is distinguished by the following advantageous characteristics. Firstly, the client 22 can constantly continue to receive updates concerning the availability of new additional contents/services with an extremely low use of computing and network resources. This eliminates most of the problems of synchronisation and allows the client 22 to remain “tuned in” to a channel and synchronised with a programme even while the user is simultaneously accessing other additional contents/services. When the user turns to the page relating to the aforementioned programme, the client 22 will use the information (the pointer to the contents) sent by the real-time push server 26 to recover the information on the additional contents/services that are still relevant.

It should be observed that, advantageously, the notification data C/S_up concerning the additional contents and/or services available can be distributed by the real time push server 26 through standard protocols and the information concerning the availability of additional contents/services can be displayed on the graphical interface 12 of the client 22 through applications already found on the market (e.g. Internet Browser).

It should also be observed that, advantageously, the additional contents/services C/S can be easily developed and tested in the production step 2 using commonly used tools (e.g. any Internet Browser).

It should also be observed that, advantageously, the additional contents/services C/S can evolve over time without needing in any way to modify the hardware/software components of the real-time push server 26 and the corresponding hardware/software components of the client 22.

It should also be observed that the client 22 is able to recover all of the information necessary for resynchronisation in a few moments after waking up from stand-by.

It should also be observed that the update frequency that can be obtained substantially depends upon the network bad available.

Finally, it should be observed that a single real-time push server 26 is able to manage tens of thousands of clients 22 connected simultaneously (i.e. that are tuned into the same channel after sending the notification request Synt_r) with very little hardware resources.

Going back to the flow diagram of FIG. 1, the method 1 comprises a subsequent step 7 of receiving an access request A_r1, A_r2 sent by the client 22 to access additional available contents/services C/S selected by the user and/or data to be recovered through the client 22 to display on the graphical interface 12 information suitable for showing the user the availability of additional contents/services C/S able to be selected and associated with the programme being broadcast.

In accordance with an embodiment, as shown in FIG. 2, the aforementioned access request A_r1, A_r2 is sent by the client 22 to a server, or hardware/software module, or distribution back end 27 operatively connected to the storage support 24.

The method 1 also comprises a step 8 of distributing to the client 22, after receiving the access request A_r1, A_r2, data C/S_a1, C/S_a2 suitable for meeting the access request. In the diagram of FIG. 2, the aforementioned distribution step 8 is carried out by the distribution back-end 27.

Again with reference to FIG. 2, two different types of access requests sent by the client 22 have been marked with A_r1 and A_r2. Indeed, it is possible to foresee that the client 22:

through a first type of request A_r2, sent by the client 22 automatically after receiving the notification data C/S_up, informs the delivery server 21 that needs to recover data CS_a2 suitable for displaying on the graphical interface 12 information on the availability of new additional contents/services;

through a second type of request A_r1, sent by the client 22 only after an input received from the user through which he selects a specific content/service that he wishes to access, informs the server 21 that it is necessary to recover data C/S_a1 suitable for actually allowing access to such a specific content/service.

In accordance with an embodiment, the aforementioned first type of request A_r2 may not be foreseen since it is possible to foresee for the same real time push server 26 after the notification request Synt_r of the client 22 to send all of the data that the client 22 needs to display on the graphical interface 12 all of the information (text/symbols/photographs) suitable for informing the user regarding the availability of additional contents/services.

As stated earlier, the real time push server 26 is intended to notify the clients 22 of the availability of additional updated contents/services that must then be suitably recovered by the client 22 itself. The distribution back end 27, on the other hand, is the component dealing with the distribution of the contents/services themselves and represents the destination from which the client 22 recovers the additional contents/services C/S. In accordance with an embodiment, such a component 27 is implemented as a high performance Application Server used to deliver critical Web services with some important specific implementation characteristics that will be detailed hereafter in the embodiments described hereafter.

In accordance with an embodiment, the presentation of the additional contents/services C/S is highly based on models. Especially during programmes broadcast live the production of the additional contents/services requires extremely short time periods and it becomes advantageous to have some prearranged presentation models ready to be filled in with the contents produced.

It has been observed that the use of the distribution back end 27 is highly asymmetrical since when a new content/service is available very many clients 22 will connect simultaneously to download it with extremely critical access peaks. In accordance with an embodiment, in order to manage such a load the distribution back end 27 can be designed so as to be able to distribute the load efficiently over many servers configured in a symmetrical cluster without maintenance of state and without session sharing. The contents can also be made available through the use of Content Delivery Network.

In accordance with a further embodiment, the distribution back end 27 could comprise cache systems distributed upstream and downstream of the Application Server. A possible configuration able to be implemented is the following:

Client 22 >First Cache level HTTP (Proxy)> Application Server;

Application Server >Distributed Cache> database 24.

It is also possible to associate load balancers capable of sorting and dividing the requests between different processing units with the distribution back end 27. With such a configuration the distribution back end 27 can easily scale down to manage hundreds of thousands or millions of users connected simultaneously.

With reference to FIG. 3 a particular example of operation of the system 20 will be briefly explained, in the hypothesis that the real time push server 26 is such as to transmit to the clients 22 just a pointer containing information suitable for allowing the clients 22 to go and recover from the distribution back-end 27 the information to be displayed on the graphical interface 12 relating to the availability of additional contents and/or services.

We will take the hypothetical case that the programme being broadcast is a television programme and that the client 22 is a cellular telephone equipped with a touchscreen display 12.

In operation, a user, by tuning into a television channel ch2, watches a television entertainment programme being broadcast, for example through a common television receiver 30 equipped with an integrated decoder and with a display 21. On the display 31 a flow of video images is then represented, a static image of which 33 showing a person, like the presenter or a guest of the television programme or an actor/character of a fictional programme, is represented as an example in FIG. 3.

A user who wishes to access additional contents/services associated with the programme being broadcast, through the client 22 selects on the touchscreen 12 of the client 22 and from a list of channels displayed on the touchscreen the channel ch2 corresponding to the channel ch2 on which the television programme is being broadcast. In response to such a selection the client 22 is configured so as to send to the delivery server 21 a notification request Synt_r. This notification request Synt_r allows the delivery server 21 to be informed that the user of the client 22 wishes to receive, in real time and in synchrony with respect to the broadcasting of the programme, notification data CS_up suitable for allowing information relating to the availability of additional contents/services associated with the programme being broadcast to be displayed on the touchscreen 12.

In response, the delivery system 21, through the scheduler 25 and the real time push server 26, broadcasts to all of the client 22 tuned in, and therefore also to the specific client 22 of the user in question a pointer (for example ID#1234) that allows the client 22 to go and recover data from the distribution back end 27 through suitable request Ar_2. Such a request Ar_2, which for example is an HTTP request, will inform the distribution back end 27 that the client 22 needs to recover data CS/a2 “pointed to” by the pointer ID#1234 suitable for displaying on the graphical interface 12 information on the availability of new additional updated contents/services.

After such a request the distribution back end 27 can send to the client 22, for example by sending data C/S_a2 in the form of a page in HTML format:

a static image 33 to be used as background and that represents a digital image taken from the flow of video images of the programme being broadcast;

data suitable for displaying on the touchscreen graphical symbols such as icons I1-I7 each corresponding to a different category of additional contents or to a respective additional service available.

For example, the icon I1 is connected by the question “Who” for which reason it is such as to inform the user that information is available relating to the story, to the identity or collateral information of one or more characters in some way connected to the programme being broadcast, including for example the presenter himself/herself or a guest on the programme, or an actor or character in the case in which the programme is a fictional programme.

The icon I2 for example relates to additional content of the “connections” type, for which reason its presence is such as to inform the user that connections to external sources are available that contain information correlated to the programme being broadcast.

Without listing the other icons in detail, it is possible, for example, to foresee;

an icon I3 corresponding to the additional contents that answer the question “What?”;

an icon i4 corresponding to additional contents in the form of digital images.

There can also be icons to access services, like for example advertising information services, remote voting services, electronic commerce services, etc.

It is also possible to foresee scroll icons I8-I9, to scroll between many static digital images 31 (and therefore in general in this example at a plurality of HTML pages displayed on the touchscreen 12), or in general with many consecutive “pages” to be displayed on the graphical interface 12, in practice each representing a static image on which the information of availability of additional contents/services able to be accessed at a given update moment are fixed. In practice, each of such pages is associated with different moments in which the contents/services have been updated, for example coinciding with passages of different portions of the programme each possibly distinguished by an associated static background image. In this way it is possible to advantageously access additional contents/services available previously and different from those exactly synchronised with the programme being broadcast.

In order to access the available contents/services, the user, selecting for example through contact with a finger one of the icons on the touchscreen 12, allows the client 22 to send a request A_r1 to access the additional contents/services C/S corresponding to the selected icon. The distribution back end 27 after such a request can deliver data to the client 22 to meet the request for example by sending digital images, text information, music files, managing interactive services etc. Once such a request has been met a “back” button will allow the user to once again display a page for example of the type of the one represented in FIG. 5, possibly in the meantime updated based on the activity of the real time push server 26.

As is clear from what has been described above through a method and a system of the type described above it is possible to fully achieve the preset purposes.

It should be observed how a method and system described above allow the experience of a user watching a television/radio programme to be enriched during a broadcast of the television programme proposing an intermediate approach, neither (like for conventional television), nor completely active (like when surfing the Internet), instead stimulating a “guided reactivity” coherent with the objective of entertaining, relaxing, intriguing and personalising.

The method and system described above are different from and radically improve the interactive TV solutions produced up to now for a series of special characteristics and it is characterised by numerous advantages.

In conventional interactive TV systems the television programmes and possible additional contents are viewed on the same device. In the system and in the method described this occurs through a dedicated tool, i.e. the client, for offering greater depth of the contents and interactivity.

It should also be observed that thanks to the presence of a dedicated client device, in the variant that foresees the innovative presentation mode (Photogram+Icon) of the available contents/services and thanks to the transmission protocol used, it is possible to send and receive in real time contents and services perfectly contextualised with the programme broadcast with continuous updating of the contents/services themselves, whereas, in conventional interactive TV the interactive services/contents vary at most every programme and often the additional content/service stays the same for all of the programmes broadcast by a channel.

It should be observed that thanks to the possibility, where foreseen, of viewing a history of the last contents/services (photograms+icons) available, the invention allows the user to view a content while the application automatically continues to update. The user can thus follow a parallel in-depth flow to then easily return to view the contents sent in real time. The user is therefore in charge of whether he will be active in accessing the proposed contents/services or passive in viewing the updates as they are sent. In conventional interactive TV there is no “history” function, the update flow and the contents displayed must of course always remain synchronised with the video transmitted, thus offering the user extremely limited interactivity.

Thanks to the particular transmission mode of the notifications and of the contents/services described above it is also advantageously possible to reduce to the minimum the energy consumption by the client and it is possible to transparently and naturally manage the possibility for the client itself to go into stand-by (video screen and network deactivated) quickly recovering the tuning and the synchronisation with the delivery server once the client is reawoken (video screen and network active).

Since the transmission and decoding of an audio flow are not required, but particularly continuous video, the client benefits from a significant reduction in hardware requirements, and therefore the costs, necessary to develop a tool to view additional contents/services.

It has been estimated that the method and system described above allow a reduction of even 90% of the data traffic necessary to convey the additional information with a clear improvement in response speed, in usability and with a substantial reduction in possible costs relating to network traffic.

Particularly, but not exclusively, in the case of additional contents/services with respect to a television programme, although it may seem that the replacement on the client of the video stream with static images (such as stills) is a regression with respect to conventional interactive TV, this technological choice proves better for numerous reasons that will be illustrated hereafter.

The combination of contents/services with a still makes the relationship between the contents themselves and the video from which the still is taken immediately clear and obvious even to the inexpert user.

The passage from one still to another, or in general from one display page to another, constitutes an immediate indication to the user that different/new contents connected to the programme segment being broadcast are available.

In the particular case of a television programme, the choice of stills to display as page background displayed through the graphical interface 12 allows the producer to focus attention on the relevant moments of a television programme.

The possibility of easily scrolling through the stills or the pages previously transmitted made available, where foreseen, allows the user to easily recover the contents sent previously. This characteristic contributes enormously to the usability of the solution since the user at any moment is able to recover the contents of interest without having to stop watching the programme.

The sending of a still takes up a very small band fraction if compared with sending a continuous video stream, and this allows more resources to be dedicated to surfing through interactive contents and substantially eliminates the delay between the transmission of the interactive contents and the video itself even in a situation of connection with limited band.

It should be observed that the presentation mode of photograms, or in general of pages, with icons is also advantageous, although to a lesser extent, in the case in which a programme is a radio programme, let us think for example of photograms that allow a user to identify a certain programme or a certain speaker or a certain programme portion or the possibility of accessing additional sports contents/services transmitted via radio.

Of course, a man skilled in the art can bring numerous modifications and variants to a method and a system of the type described above, in order to satisfy contingent and specific requirements, all of which are in any case covered by the scope of protection of the invention, as defined by the following claims.

1-15. (canceled)

16. A method for real time delivery to at least one user additional content/services associated with a program broadcast by television/radio and intended to be received/used by the user through a standard television/radio receiving device, the additional content/services being suitable for being accessed by the user through a client device equipped with a graphical display interface distinct from the standard television/radio receiving device, the method comprising the steps of:
a) providing a hardware/software module for sending notifications with updated data relating to the availability of said additional content/services;
b) transmitting to the client device through the hardware/software module for sending notifications, while the program is being broadcast and in synchrony with it and after a notification request sent by the client device has been received, notification data suitable for allowing information relating to the availability of additional content/services associated with the broadcast program to be displayed on the graphical interface of the client device, the transmitting step being carried out periodically according to update periods of predetermined and/or variable duration based on real time updating of additional content/services available associated with the program; and
c) distributing data to the client device to allow an access request of the client device to be met, the distributing step being carried out after receiving said access request sent by the client device in order to access additional content/services available selected by the user and/or data to be recovered through the client device for displaying on the graphical interface said information suitable for showing the user the availability of selectable additional content/services associated with the program being broadcast;
wherein the notification data is in the form of one or more pointers suitable for allowing the client device to:
recover said data suitable for displaying on the graphical interface information concerning the availability of additional content/services associated with the program being broadcast and able to be selectively accessed by the user, or
directly recover the additional content/services themselves.

17. The method of claim 16, wherein the hardware/software module for sending notifications comprises a real time push server coordinated by a scheduler module provided to synchronise with respect to the program the notification data to be transmitted in step b).

18. The method of claim 17, wherein distributing step c) is carried out through a distribution back end distinct from the hardware/software module for sending notifications.

19. The method of claim 16, wherein the transmitting step b) comprises an operation of transmitting to the client device a digital image correlated to the program or data suitable for allowing the client device to recover such an image, in order to display said digital image as background of a page displayed on the graphical interface until a different input by the user or for the entire duration of an update period, and wherein the information relating to the availability of content is such as to be able to be displayed in said page through symbols, windows, texts, hypertext connections or icons over the top of said digital image displayed as page background.

20. The method of claim 19, wherein the program is a television program and wherein said digital image is a photogram selected and sampled from a video stream and intended to be displayed as a still on the graphical interface.

21. The method of claim 19, comprising a step of displaying said page and said information through the graphical interface and wherein the displaying step allows the user to browse between a plurality of pages to review a predetermined or configurable number of displayable digital pages prior to the most recent page displayed.

22. The method of claim 16, further comprising a step of storing additional content/services associated with the program and wherein the providing step a) comprises an operation of sending to the hardware/software module data relating to the availability of additional stored content/services.

23. The method of claim 16, further comprising a step of producing additional content/services and wherein said producing step is carried out using editing software based on production models to be compiled that allow both production in real time and in advance with respect to said broadcast.

24. A telecommunications system comprising a delivery server suitable for actuating the method of claim 16.

25. A delivery server for real time delivery to at least one user additional content/services associated with a program broadcast by television/radio and intended to be received/used by the user through a standard television/radio receiving device, the additional content/services being suitable for being accessed by the user through a client device equipped with a graphical display interface distinct from the standard television/radio receiving device, the server comprising:
a) a hardware/software module for sending notifications adapted for receiving updated data relating to the availability of said additional content/services and for transmitting to the client device, while the program is being broadcast and in synchrony with it and after receiving a notification request sent by the client device, notification data suitable for allowing information relating to the availability of additional content/services associated with the program being broadcast to be displayed on the graphical interface of the client device, said hardware/software module for sending notifications being such as to carry out said transmission periodically according to update periods of predetermined and/or variable duration based on updating in real time of additional available content/services associated with the program; and
b) a hardware/software distribution module, suitable for distributing data to the client device to allow an access request of the client device to be met, said hardware/software distribution module being such as to distribute said data to the client device after receiving said access request sent by the client device in order to access additional available content/services selected by the user and/or data to be recovered through the client device to display on the graphical interface said information suitable for showing the user the availability of additional content/services able to be selected and associated with the program being broadcast;
wherein the notification data is in the form of one or more pointers suitable for allowing the client device to:
recover said data suitable for displaying on the graphical interface information concerning the availability of additional content/services associated with the program being broadcast and able to be selectively accessed by the user; or
directly recover the additional content/services themselves.

26. The system of claim 24, wherein the hardware/software module for sending notifications comprises a real time push server and a scheduler module for coordinating the real time push server to synchronise the notification data to be transmitted with respect to the program.

27. A client device comprising a processor, a display client device, a memory and portions of code able to be loaded directly into the memory and able to be executed through the processor to allow said client device to interface with the system of claim 24, in order to allow said user to access said additional content/services.

28. The client device of claim 27, wherein said client device is a mobile telephone.

29. The client device of claim 27, wherein said client device is a multimedia remote control.
